(19) United States
(12) Patent Application Publication
(10) Pub. No.: US 2026/0271913 A1
(43) Pub. Date: Sep. 17, 2026

(54) REFRIGERATED WILD GAME COOLER BAG AND METHOD OF USE

(71) Applicant: Brandon Witkowski, Saginaw, MO (US)

(72) Inventor: Brandon Witkowski, Saginaw, MO (US)

(21) Appl. No.: 19/080,433

(22) Filed: Mar. 14, 2025

(51) Int. Cl. A01M 31/00; B65D 81/38

(52) U.S. Cl. CPC A01M 31/006; B65D 81/3895; B65D 2313/00

(57) ABSTRACT

The present disclosure provides a system for cooling an animal carcass in the field and a method for using the same. The system includes an insulated bag, a portable refrigeration unit, and a tubular connector linking the two to facilitate the transport of cold air into the insulated bag. The system further comprises a series of channels into which ice or other cold material may be inserted to facilitate cooling. Associated straps, hooks, and loops facilitate the use of the system. A four-layer insulated lining with suggested materials makes up the bulk of the insulated bag. The method of using said system involves wrapping an animal carcass in the unfolded bag, zipping it closed, securing the bag about the animal by use of straps, and either hanging or transporting the bag with the secured carcass.

### FIELD OF INVENTION

The present disclosure relates to devices for preserving animal carcasses, and more particularly to bags for preserving and transporting game animals.

### BACKGROUND

Preserving game animals in the field has long been a challenge for hunters and outdoor enthusiasts. Traditionally, hunters have relied on various methods to keep harvested animals fresh until they can be properly processed. These methods often include field dressing the animal, cooling the carcass with ice or snow, and transporting it in a timely manner to a processing facility or home freezer. For particularly large game, field quartering is sometimes necessary to facilitate efficient cooling and the removal of internal fluids. In most situations, removal of the animal from warm temperatures, dirt, and exposure to insects is crucial to preventing spoilage; to that end, hunting bags have come into common use to allow air circulation without allowing the carcass to get dirty.

Given the aforementioned advantages, non-refrigerated bags for transporting game animals have been used as a convenient means of moving harvested animals from the field. However, these bags face several challenges in maintaining the quality and safety of the meat. Without proper temperature control, bacteria can multiply rapidly, leading to spoilage and potential health risks. Additionally, non-refrigerated bags made from breathable materials may not effectively protect the carcass from external contaminants or insects, which can further compromise the meat quality. While these factors may not be pressing concerns for hunters in cold, dry areas with low insect loads, higher ambient temperatures, meaningful humidity, and exposure to sunlight can significantly impact the effectiveness of non-refrigerated game bags. In warmer climates or during hot seasons, the rate of bacterial growth and meat degradation accelerates, making it crucial to cool the carcass quickly and maintain a low temperature throughout transport. Furthermore, prolonged exposure to heat can cause undesirable changes in the meat's texture, color, and flavor.

The limitations of non-refrigerated game bags have led to a need for more advanced solutions in game preservation and transport. Hunters and wildlife managers seek methods that can extend the viable preservation time of harvested animals, particularly in situations where immediate processing or refrigeration is not possible. Improved preservation techniques not only enhance food safety but also contribute to reducing waste and maximizing the utilization of harvested game animals.

The present disclosure addresses pressing concerns with game bag functionality by incorporating multiple cooling technologies into a game bag apparatus. A small refrigeration unit connected by a sturdy tube ensures cooling and air circulation. Cooling may be supplemented with ice added to side channels. An open mouth sealable with a drawstring allows blood and other fluids to freely exit the carcass and bag in the field. Appropriate for both field transport of game carcasses and their storage prior to processing, the invention disclosed herein considerably eases the burden of carcass preparation and relocation for hunters and outdoor enthusiasts.

### SUMMARY

An insulated, refrigerated bag for the cooling, preservation, and storage of animal carcasses in the field is provided. In one aspect, the present invention is a device that facilitates transport of dead game animals in a way that reduces the risk of unsanitary spreading of blood and other fluids. In another aspect, the present invention is a means by which animal carcasses may be preserved in warm weather prior to butchering and storage. In yet another aspect, the present invention is a device that facilitates the draining and aging of meat in suboptimal environmental conditions. In still another aspect, the present invention is a method of using a refrigerated bag in the field to preserve game for transport. Generally, the present invention replaces non-refrigerated coolers or hunting bags to reduce carcass spoilage in the field.

The present invention comprises an insulated bag with four layers of material, each of which contributes at least one functionality to the structure as a whole. In general, the outermost layer is designed for durability to prevent damage to the bag. The first middle layer is designed to deflect radiant heat. The second middle layer is primarily insulation. The innermost layer is waterproof, durable, and antimicrobial to facilitate cleaning and bag reuse. The insulated bag further includes cooling channels configured to hold ice, wherein the cooling channels are designed to drain to the exterior of the bag. The cooling channels may be integrated within one or more of the four layers of insulation material. The cooling channels may be designed to distribute ice evenly throughout the bag for efficient cooling. The insulated bag also includes a zipper on one side of the bag for opening and closing the system such that the system when unzipped lies flat without vertical protrusions.

Said insulated bag includes one or more of the following features. The insulated bag may include straps for carrying the bag, hanging the bag, or both. The insulated bag may further include a tube and an access port, wherein the tube and access port are configured to connect to an associated small refrigeration unit that circulates air within the bag. The insulated bag includes a mouth adjustable via a drawstring at the base of the bag. The mouth may be configured to allow water, blood, or other liquids to exit the bag when the bag is in a hanging configuration, thereby facilitating the removal of blood from the carcass without pooling. A loop appropriate for suspending the bag and a carcass contained within is localized at the opposite end of the bag. The edge opposite the mouth is sealable via complementary Velcro patches to prevent the escape of cold air.

The associated small refrigeration unit may be detachable from the insulated bag and work in conjunction with ice in the disclosed cooling channels. The refrigeration unit may be configured to provide additional cooling capacity when connected to the bag via the tube and access port. With these features, the disclosed invention may be applied to various situations, such as food storage, medical supply transport, or outdoor recreational use. The four layers of insulation material provides enhanced thermal efficiency compared to bags with fewer or thicker insulation layers.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. For instance, though depicted with dimensions appropriate for the transport of a moderately sized game animal like white-tailed deer, one could modify the bag to better fit larger or smaller game animals without departing from the inventive disclosure.

Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

These and other features, aspects, and advantages of the present invention will become better understood with regard to the following description, appended claims, and accompanying drawings where:

FIG. 1 illustrates a top view of the invention, showing the outer layer of the bag, access port for refrigeration, ice channels, and associated straps consistent with the principles of the present disclosure.

FIG. 2 illustrates a side view of the invention, showing the laying orientation, tubular connector, and associated refrigeration unit consistent with the principles of the present disclosure.

FIG. 3 illustrates a view of the invention in an opened configuration such that the zipper is visible and an internal view of the ice channels is present consistent with the principles of the present disclosure.

FIG. 4 illustrates the structure of the lining of the bag, including the structure of the access port for refrigeration consistent with the principles of the present disclosure.

FIG. 5 illustrates a depiction of the invention in use, with a game animal carcass cooled by the interior consistent with the principles of the present disclosure.

FIG. 6 illustrates a depiction of the invention in use in its hanging configuration and the drain at its base consistent with the principles of the present disclosure.

FIG. 7 illustrates a flowchart detailing the method of utilizing the invention to preserve, hang, or transport an animal carcass consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. As defined herein, the word substantial means more than half of the length.

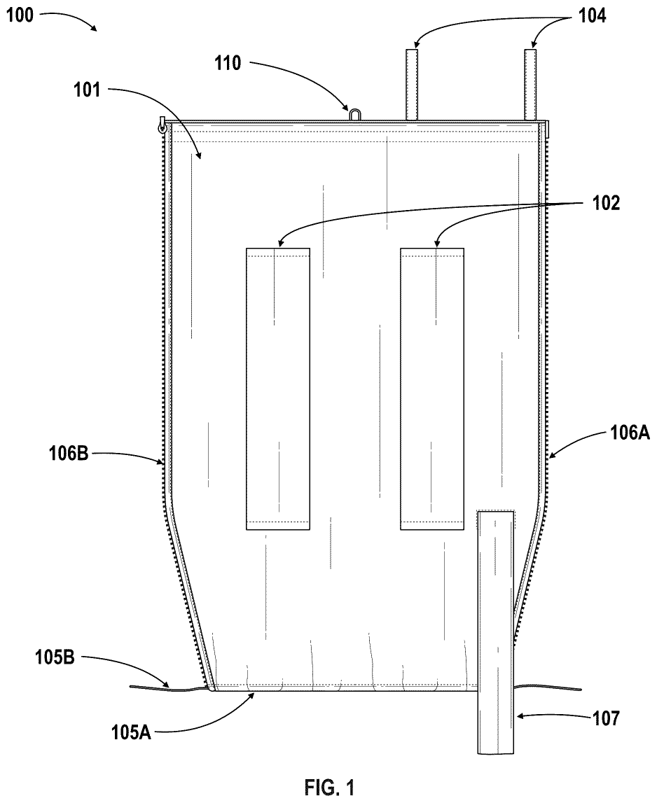

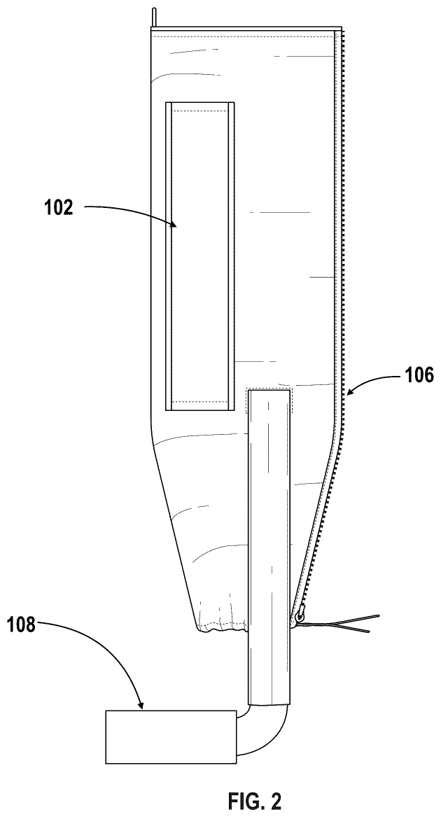

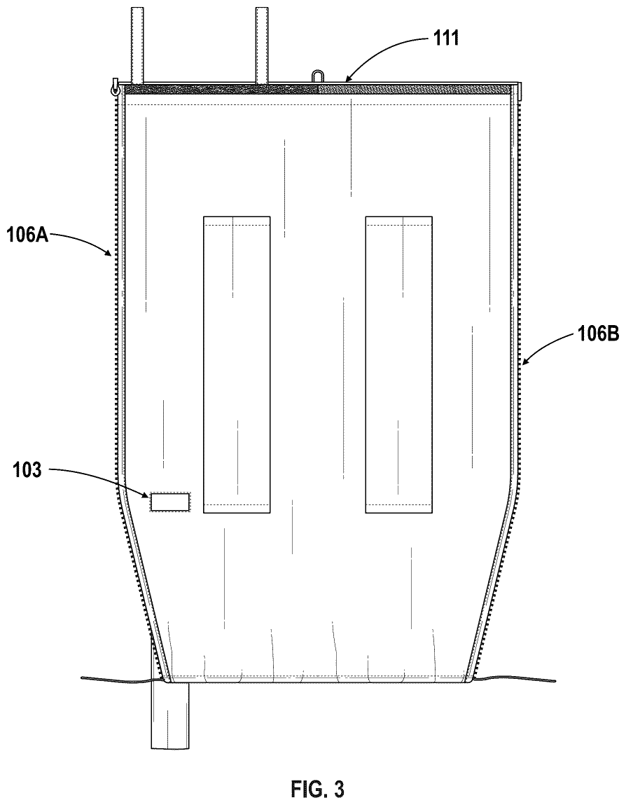

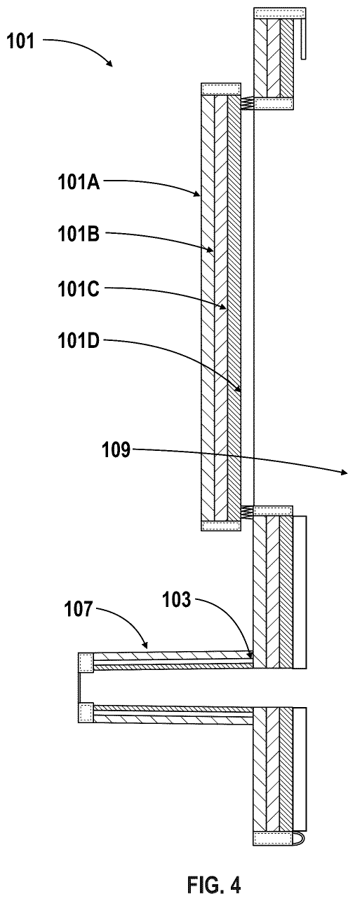

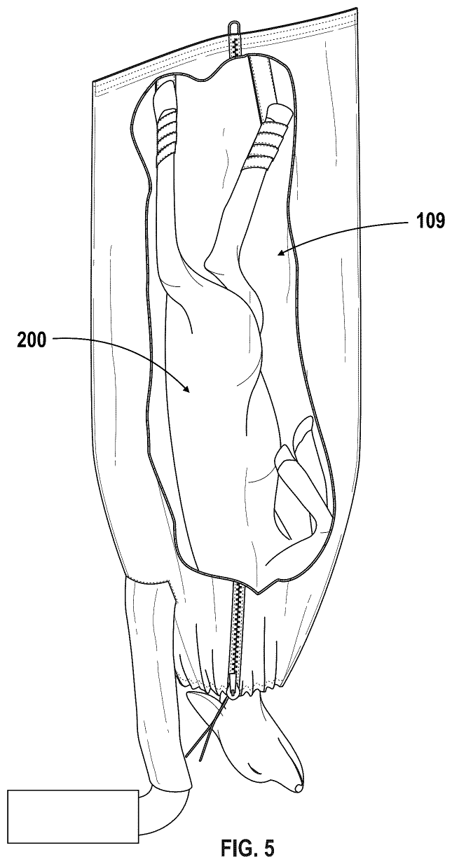

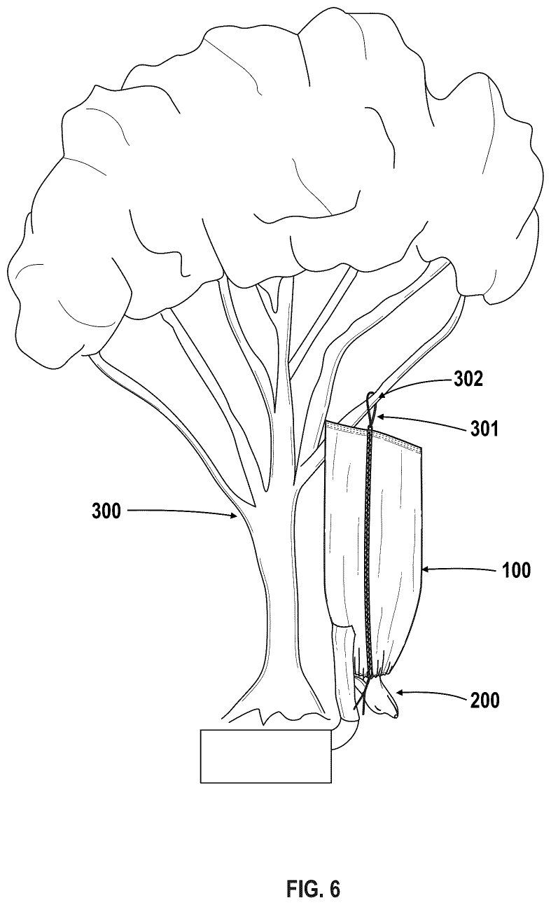

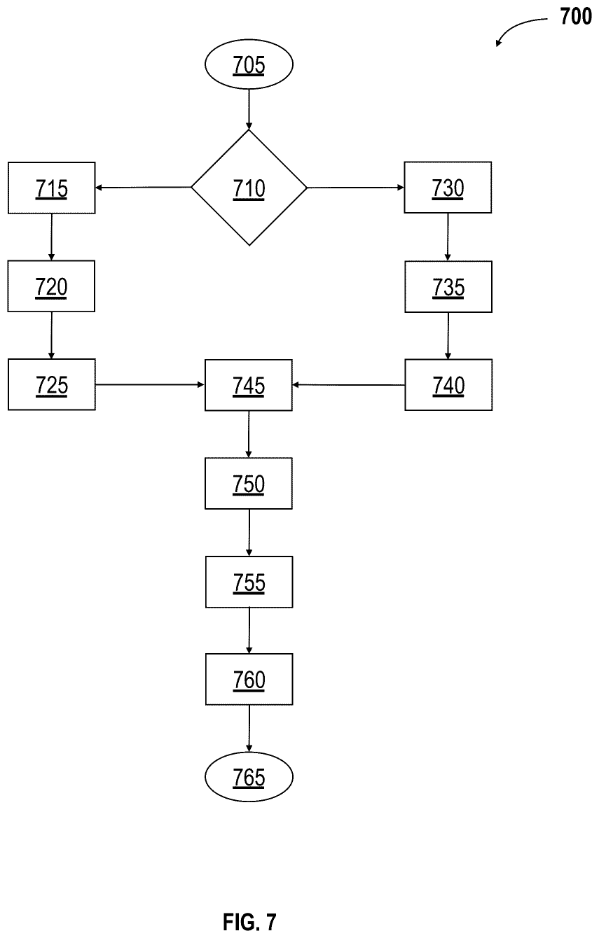

FIGS. 1-7 illustrate a preferred embodiment of a system 100 designed to preserve animal carcasses at refrigerated temperatures for storage and transport. FIG. 1 illustrates the exterior view of the system 100, showing the insulated bag 101, ice channels 102, hanging straps 104, bottom opening 105 with string sleeve 105A and drawstring 105B, first zipper half 106A, second zipper half 106B, tubular connector 107, and hanging loop 110. FIG. 2 illustrates a side view of the invention and a preferred laying orientation, wherein an ice channel 102, bottom opening 105 with string sleeve 105A and drawstring 105B, zipper 106, tubular connector 107, refrigeration unit 108 (operably connected to the system via the tubular connector 107), and hanging loop 110 are visible. FIG. 3 illustrates an interior view of the system 100, showing the ice channels 102, access port 103, hanging straps 104, hanging loop 110, and the closable lining 111. FIG. 4 illustrates a preferred embodiment of the internal structure of the insulated lining 101, including the structure of the tubular connector 107 and access port 103. FIG. 5 illustrates a preferred embodiment of the system 100 in use in a hanging configuration, wherein a game animal carcass 200 is being cooled within the inner cavity 109 created by the system when placed in a closed position. FIG. 6 illustrates a preferred embodiment of the system 100 in use in a hanging configuration within an environment. FIG. 7 illustrates a flowchart detailing the method of utilizing the invention to preserve, hang, or transport an animal carcass 200. It is understood that the various method steps associated with the methods of the present disclosure may be carried out as operations by the system 100 shown in FIG. 1.

As illustrated in FIG. 1, the system 100 comprises an insulated bag 101 appropriate for the transport of animal carcasses. Generally speaking, the insulated bag 101 is of dimensions appropriate for the transportation of at least one moderately sized game animal. In a preferred embodiment, the insulated bag 101 measures 84 inches long and 60 inches wide when in a closed position. The insulated bag 101 is preferably moderately tapered towards its bottom opening 105 in a way such that the bottom opening 105 is narrower than the bag at its broadest point. In a preferred embodiment, the insulated bag 101 is not tapered for the top 60 inches of its length but is tapered for the bottom 24 inches of its length. In other preferred embodiments, the insulated bag may be taper towards the top opening. Accordingly, in some preferred embodiments, the width of the insulated bag 101 may vary about the length. In a preferred embodiment, a zipper 106 is secured to the insulated bag 101, wherein the zipper comprises a first zipper half 106A and a second zipper half 106B that run longitudinally from the opening 105 of the bag to the top end. A closable lining 111 secured to the top end of the insulated bag 101 may allow for an opening located at the top end to be closed during normal use. In a preferred embodiment, when the zipper is unzipped and the closable lining 111 is opened, the insulated bag 101 may be placed in an open position, as illustrated in FIGS. 1 and 3. When the zipper is zipped and the closable lining 111 is closed, the insulated bag 101 may be placed in a closed position, as illustrated in FIGS. 2, 5, and 6. In a preferred embodiment, the zipper 106 is weatherproof, waterproof, and treated with antimicrobial compounds. In another preferred embodiment, the zipper 106 is of heavy, durable make. In still another preferred embodiment, the zipper 106 is reenforced with a seam cover lined with fastening means. In yet another preferred embodiment, the zipper 106 is replaced by a continuous, durable fastening means appropriate for keeping the insulated bag 101 in a closed configuration.

The insulated bag 101 has a bottom opening 105 at one end. In the exemplary embodiment, the bottom opening 105 comprises a drawstring housing 105A and a drawstring 105B so that the size of the bottom opening can be adjusted via cinching or releasing the drawstring 105B. In a preferred embodiment, the drawstring housing 105A is composed of highly durable material in order to resist the stresses of frequent adjustment. For instance, drawstring housing 105A might be constructed of heavy canvas or Kevlar. In another preferred embodiment, the drawstring 105B is composed of likewise heavyweight and durable material to resist weathering, tearing, and rot. When the system 100 is in use, the drawstring 105B can be tightened to secure the opening 105 about the head and neck of an animal carcass 200, thus stabilizing it and keeping said carcass in place during hanging or transport. In a preferred embodiment, the drawstring 105B can be fixed in a certain degree of cinching or unfastening via tying a knot. In another preferred embodiment, the drawstring 105B can be fixed in a certain degree of cinching or unfastening via a clip or other fastening means.

A tubular connector 107 secured and/or incorporated into the exterior of the insulated bag allows for the passage of cold air when connected to a refrigeration unit 108. The cold air enters the inner cavity 109—created by the system 100 when placed in a closed position-via an access port 103 of the tubular connector. The refrigeration unit 108 is configured to direct cold air through the tubular connector 107 and access port 103 and into the inner cavity 109 of the insulated bag. Accordingly, the passage created by the tubular connector 107 and access port 103 allows for controlled refrigeration of an animal carcass 200 via a refrigeration unit 108. In a preferred embodiment, the refrigeration unit 108 draws air from the environment, cools it, and directs it into the inner cavity 109. The air then flows out an opening. In another preferred embodiment, the refrigeration unit 108 recirculates the air already present in the inner cavity 109, thereby improving system efficiency if said inner cavity 109 is already cooler than the surrounding environment. In yet another preferred embodiment, the refrigeration unit 108 comprises muffling technology to reduce noise pollution and avoid driving away wildlife in the field. Generally, the refrigeration unit 108, tubular connector 107, and access port 103 are crucial to the function of the system as a whole and maintain a cold inner cavity 109 even in warm environments where animal carcasses spoil quickly and ice cannot be found.

In some preferred embodiments, the system 100 further comprises one or more ice channels 102 built into the exterior and/or interior of the insulated bag 101. The ice channels 102 may be defined as an unpowered cooling system that work separately from or in concert with the associated refrigeration unit 108. In a preferred embodiment, the ice channels 102 comprise pockets or sleeves on the exterior and/or interior of the bag into which cold material may be inserted. The cold material operates to cool the inner cavity 109 through contact with the lining of the ice channel 102. In a preferred embodiment, the cold material comprises ice, in cubed, crushed, or block forms. In another preferred embodiment, the cold material comprises a phase change material that may be or may not be removable from the ice channels 102. In yet another preferred embodiment, the cold material comprises dry ice. Selection of an appropriate cooling material can effectively speed the cooling of the inner cavity 109 in a way that would not be possible with the refrigeration unit alone.

In a preferred embodiment, the ice channels 102 are built into the lining of the insulated bag proper, in between two of the four layers. For example, the ice channels 102 may be built in between layer 101C and 101D, such that 101D is the only layer separating the cold material from the inner cavity 109. In such an embodiment, the layer 101D might incorporate phase-change materials (PCM) to facilitate steady, robust cooling and absorbance of heat by the cold material. In yet another preferred embodiment, one end of the ice channel 102 is open while the other is comprised of a porous stitching or material like mesh in order to allow condensation or meltwater to escape. In still another preferred embodiment, one or more of the ends of the ice channel 102 are transiently sealable with affixing means such as hook-and-loop patches, buttons, clasps, or magnetic strips. In such an embodiment, the cold material would be at reduced risk of falling out of the ice channel or absorbing heat via convection from the surrounding environment. If only one end of the ice channel 102 is transiently sealable in this manner, one might position the sealable end so that it is directed towards the opening 105; by this means, the open end would be positioned superior to the sealable end when the system 100 is in its hanging configuration.

FIG. 2 illustrates a side view of the system 100 in a zipped, partially cinched configuration. The bag opening 105 is shown to be partially closed and cinched, with drawstring 105B protruding from drawstring housing 105A. One ice channel 102 is observable on the insulated bag 101, as is the tubular connector 107 connecting to the associated refrigeration unit 108. In a preferred embodiment, the tubular connector 107 is permanently attached to the associated refrigeration unit 108. In another preferred embodiment, the tubular connector 107 is detachable from the associated refrigeration unit 108. In still another preferred embodiment, the tubular connector 107 is separable from the access port 103. Such an embodiment might find a way to repurpose the disconnected tubular connector 107 when not in use. For instance, the tubular connector 107 might further comprise fastening means on each end so that if the insulated bag 101 were folded or rolled up the tubular connector could wrap around and secure the insulated bag in such a configuration. Alternatively, the tubular connector might be transiently affixed to the refrigeration unit 108 to function as a handle for easier transportation. In yet another preferred embodiment, the associated refrigeration unit 108 comprises a chargeable battery pack so that it is usable in the field where access to electricity is intermittent or absent.

FIG. 3 illustrates a back of the system 100 in an open position. An internal view of access port 103 for refrigeration is observable near the opening 105 of the system 100. However, the access port 103 may be located in other positions without departing from the inventive subject matter described herein. The two halves 106A and 106B comprising zipper 106 define the sides of the bag, as they do in FIG. 1. In some preferred embodiments, an additional fastening means may be used to aid the zipper 106 in securing the system 100 in a closed position. The hanging straps 104 are present on or near the closable lining 111 of the system 100 at the top end and is configured in a way such that the insulated bag 101 may be sealed from the top end with said lining when the bag is folded over itself and the halves of the zipper 106 are aligned. In the preferred embodiment, the closable lining 111 comprises Velcro® or a similar hook-and-loop fastener. However, alternative embodiments may incorporate a series of snap fasteners or buttons along the edge, allowing for secure closure while maintaining ease of use. In another preferred embodiment, the closable lining 111 may utilize a magnetic closure system. For example, thin magnetic strips embedded within the lining material may provide a seamless and easily adjustable seal at the top end. The closable lining 111 may be incorporated into or distinct from zipper 106. Such an embodiment might utilize a waterproof or water-resistant zipper to enhance the bag's weatherproofing and insulating capabilities. In some embodiments, the closable lining 111 may feature a roll-top closure, similar to those used in dry bags, which can be folded over multiple times and secured with buckles or clasps to create a watertight seal. In still another preferred embodiment, the closable lining 111 may incorporate a drawstring or cord-lock system, allowing users to cinch the opening closed and secure it in place. In yet another preferred embodiment, the closable lining 111 may use an adhesive strip system, with a removable protective layer that can be peeled off to expose a tacky surface for sealing. This system may be particularly useful for single-use applications or situations where a very tight seal is required. For situations requiring a more robust closure, the closable lining 111 may employ a track-and-slider system similar to those used in resealable plastic bags, but on a larger scale and with more durable materials. In some cases, the closable lining 111 may utilize a combination of closure methods, such as a zipper with an overlapping flap secured by snaps or magnets, to provide multiple layers of sealing.

FIG. 4 illustrates a preferred structure of the insulated bag 101 comprising a first layer 101A, second layer 101B, third layer 101C, and fourth layer 101D, wherein each layer contributes a distinct functionality to the insulated bag 101. In a preferred embodiment, the first layer 101A comprises the outermost layer of the bag. In a preferred embodiment, the first layer 101A is configured for durability, particularly in the areas of abrasion resistance, tearing resistance, or puncturing resistance. In some preferred embodiments, the first layer 101A may further comprise water resistant properties. In other preferred embodiments, the first layer 101A may further comprise hanging straps 104 and/or hanging loops 110. In a preferred embodiment, the first layer 101A may be composed of durable materials such as 1000D textured nylon, ballistic or ripstop nylon, treated canvas, high-density polyethylene (HDPE), Kevlar, Dyneema composites, polyester, or PVC-coated polyester, each selected for their specific properties of abrasion resistance, tear strength, and overall durability.

In a preferred embodiment, the second layer 101B is configured to deflect radiant heat from the exterior environment, thereby improving the thermal efficiency of the bag. In a preferred embodiment, the second layer 101B comprises the layer immediately beneath the first layer 101A. In some preferred embodiments, the second layer 101B may be interwoven with the first layer 101A to form a composite layer which is both durable in the face of most environmental conditions and capable of deflecting most radiant heat. In a preferred embodiment, the second layer 101B may comprise materials such as aluminum-bonded substrates, metallized polyethylene terephthalate (PET) films, radiant barrier fabrics, ceramic-infused fabrics, nano-coated fabrics, carbon fiber composites, or reflective polyester films, each selected for their ability to effectively reflect infrared radiation and enhance the bag's thermal efficiency. In embodiments defining the second layer 101B as its own layer rather than as a composite or coating, careful selection of materials may ensure efficacy and cohesiveness. For example, infrared-reflective pigments, like those containing titanium dioxide, may be applied to or incorporated within a fabric or material that may then be used to create the second layer 101B. For example, the second layer 101B may comprise substrate bonded aluminum, such as reflective foil insulation or aluminized mylar. Similarly, the second layer may comprise metallized polyethylene terephthalate (PET) film, radiant barrier fabric, or other metallic-coated fabrics like Temptrol® to make use of metallic coatings for their reflective properties.

In a preferred embodiment, the third layer 101C is configured to provide insulation and is the layer immediately beneath the innermost layer. Accordingly, the third layer 101C preferably reduces the passage of heat from the exterior of the bag to the inner cavity 109, wherein said inner cavity 109 contains the animal carcass. In some preferred embodiments, the third layer 101C is interwoven with the second layer 101B or treated with infrared-reflective pigments to form a composite layer. In another preferred embodiment, the third layer 101C may be treated or constructed to be antimicrobial, anti-fungal, waterproof, or any combination thereof. The third layer 101C may be created using one or more materials configured to reduce thermal transmission. In a preferred embodiment, the third layer 101C may comprise materials such as aerogel-based composites, closed-cell foam, cross-linked polyethylene foam, synthetic insulation like Thinsulate™ or Primaloft®, microfiber insulation, hollow fiber insulation, or phase change materials (PCMs) embedded in a flexible substrate, each selected for their thermal insulation properties, flexibility, and ability to maintain insulating effectiveness under various conditions. For example, an insulated bag 101 having a third layer 101C comprising aerogel-based materials may offer excellent thermal insulation properties while remaining thin and flexible. For example, an insulated bag 101 having a third layer 101C comprising aerogel blankets, infused fabrics, or composites may be used to provide high thermal resistance with minimal thickness and low mass. For example, a bag having a third layer comprising closed-cell foam, such as neoprene or ethylene-vinyl acetate (EVA) foam may have effective insulation properties while maintaining flexibility and durability. In a highly preferred embodiment, cross-linked, dense polyethylene foam is used to create the third layer 101C due to its combination of insulation properties and moisture resistance. Materials such as Thinsulate™ or Primaloft® may be incorporated into the third layer 101C to create a bag having high insulation value relative to its thickness/weight that can even retain its insulating properties when compressed or damp. Similarly, microfiber insulation, composed of extremely fine synthetic fibers, may be used to construct the third layer 101C. In another preferred embodiment, hollow fiber insulation may be employed for its ability to provide warmth with minimal weight and bulk. In a highly preferred embodiment, the third layer 101C may utilize or incorporate PCMs embedded in a flexible substrate. PCMs can absorb, store, and release heat, thereby helping to maintain a stable temperature within the bag. Future development may allow for the third layer 101C to be thin layers of vacuum insulated panels (VIPs). While traditionally rigid, advances in flexible VIP technology may allow for their incorporation into the bag's insulation system, potentially providing superior insulation in a compact form.

The fourth layer 101D may be configured to provide a durable, waterproof, and easily cleanable surface that comes into direct contact with the animal carcass, potentially incorporating antimicrobial properties to enhance hygiene and prevent contamination during storage and transport. In a preferred embodiment, the fourth layer 101D is the innermost layer of the insulated insulated bag 101 and is therefore the layer making regular contact with animal carcasses. In a preferred embodiment, the fourth layer 101D is composed of materials such as nonporous PVC backed nylon, silicone-coated fabrics, polyurethane-coated substrates, thermoplastic polyurethane (TPU) films or laminates, fluoropolymer-based fabrics or coatings like polytetrafluoroethylene (PTFE), advanced textile technologies like nanofabrics or nanocoatings, or composite materials combining multiple layers or properties, each selected for their durability, ease of cleaning, waterproofing capabilities, and potential to incorporate antimicrobial properties. For example, the fourth layer 101D may comprise silicone-coated fabrics to create an insulated bag 101 having excellent waterproofing, durability, and ease of cleaning properties while maintaining flexibility. For example, the fourth layer 101D may utilize thermoplastic polyurethane (TPU) films or laminates to create an insulated bag 101 having excellent abrasion resistance, waterproofing, and flexibility. All these synthetic embodiments may furthermore be engineered to incorporate other desired properties. For example, a layer combining a durable woven fabric with a waterproof and antimicrobial coating or membrane may provide the desired combination of properties.

As illustrated in FIG. 4, the tubular connector 107 comprises a hose that directs cold air from the refrigeration unit 108 into the inner cavity 109, with air escaping from the drawstring mouth or any gaps in the Velcro edge. In another preferred embodiment, said hose is composed of the same four-layered structure as the material of the insulated bag 101. In yet another preferred embodiment, the tubular connector comprises two hoses 107A and 107B; the first hose 107A directs cold air into the inner cavity 109 while the second hose 107B draws air from the inner cavity inner cavity 109 and directs it back to the refrigeration unit 108. In still another preferred embodiment, the hoses 107A-107B are not irreversibly joined side-by-side but can be manipulated separately and joined to the refrigeration unit in different places. This arrangement allows for greater diversity in the structure of the refrigeration unit 108; the ability to disentangle input and output hoses permits the refrigeration unit 108 to separate air intake from air output, improving efficiency.

In a preferred embodiment, the animal carcass 200 is any species of game or sport animal that can fit within the insulated bag 101 in a closed configuration. In still another preferred embodiment, the animal carcass 200 is any species of animal which the user finds desirable to preserve via refrigeration. For instance, a farmer wishing to transport a slaughtered sheep to a butcher might use the disclosed invention to cool and transfer the carcass. Similarly, a user wishing to transport a large harm, leg of mutton, or other uncooked piece of meat necessitating refrigeration could efficiently utilize the invention, obviating the need for a refrigerated truck or an expensive, bulky cooler.

FIG. 5 illustrates the invention in use, wherein a white-tailed dear carcass is located within. As illustrated in FIG. 5, the hanging straps 104 are preferably secured about the legs of the animal carcass 200 and to the insulated bag 101. In a preferred embodiment, the straps are secured to the exterior of the bag. For instance, the straps may be secured to one or more layers 101A-101D of the insulated bag 101, starting with the first layer 101A. In another preferred embodiment, the hanging straps 104 may be affixed to the bag on or within the closable lining 111. For example, the hanging straps 104 may be sewn directly into the seam where the closable lining 111 meets the main body of the bag. In yet another preferred embodiment, the straps are secured to the exterior of the bag. For example, the straps may be secured to one or more layers 101A-101D of the insulated bag 101, starting with the fourth layer 101D. In some preferred embodiments, the hanging straps 104 may be attached to reinforced patches. For instance, the straps may be attached to reinforced patches on the interior of the closable lining 111, providing additional strength and durability. In some cases, the hanging straps 104 may be integrated into the closable lining 111 itself, with portions of the straps extending out when the lining is opened. In still another preferred embodiment, the hanging straps 104 may be attached to the insulated bag 101 using a combination of sewing and reinforced patches. These patches, which may be made from materials such as leather or high-strength synthetic fabrics, can be sewn onto the insulated bag 101 and serve as anchor points for the hanging straps 104.

The hanging straps 104 are configured to hold the animal carcass 200 suspended within the bag so the full weight of the animal carcass does not stress or stretch the bag opening 105. To enhance the versatility of the hanging straps 104, they may be designed with multiple attachment points along the length of the insulated bag 101. This configuration may allow users to adjust the position of the animal carcass within the bag for optimal weight distribution and cooling efficiency. The hanging straps 104 may also incorporate adjustable features to accommodate different sizes of animal carcasses. In some embodiments, the hanging straps 104 may include buckles or ladder locks that allow for length adjustment. These adjustable features may be made from durable plastic or metal materials that can withstand repeated use and exposure to various environmental conditions. In yet another preferred embodiment, the hanging straps 104 may be designed with quick-release mechanisms to facilitate easy attachment and detachment of the animal carcass. These mechanisms may include heavy-duty plastic or metal clips that can be quickly engaged or disengaged. In a highly preferred embodiment, the hanging straps 104 incorporate Velcro® or hook-and-loop fasteners to provide additional securing options. These fasteners may be strategically placed along the length of the straps, allowing users to create secure loops around the animal carcass or attach the straps to complementary fasteners on the interior of the insulated bag 101.

The hanging straps 104 may be constructed from a variety of materials to ensure durability, strength, ease of use, and resilience against microbial or fungal growth. In a preferred embodiment, the hanging straps 104 are made from high-strength nylon webbing, which offers excellent tensile strength and resistance to stretching. In another preferred embodiment, the hanging straps 104 are constructed from polyester webbing, which provides good durability and resistance to UV degradation. In yet another preferred embodiment, the hanging straps 104 are made from reinforced materials such as Kevlar-reinforced nylon or polyester to provide additional strength and puncture resistance. These reinforced materials may be particularly useful when handling larger or heavier animal carcasses. In some preferred embodiments, the ends of the hanging straps 104 are reinforced with additional material or stitching to prevent fraying and extend the lifespan of the straps. In some cases, the ends may be capped with durable plastic or metal components to further protect against wear and tear. In another preferred embodiment, the hanging straps 104 may feature textured surfaces or rubberized sections to improve grip and prevent slippage. These features may be particularly useful when handling wet or slippery animal carcasses, providing additional security during transport and storage.

As illustrated in FIG. 6, the system 100 is in its closed and hanging configuration, suspended from a hanging loop 110. The hanging loop 110 may serve as an attachment point for hanging means 301, which connects the system to an anchor point 302. In a preferred embodiment, the hanging means 301 may comprise a rope. For example, the rope may be a durable nylon or polyester rope capable of supporting the weight of the system and animal carcass. In some cases, the rope may include a pulley system to assist in raising and lowering the bag. In another preferred embodiment, the hanging means 301 may comprise one or more straps. For example, the straps may be made of durable nylon webbing capable of supporting the weight of the system and animal carcass. In some cases, the straps may include adjustable buckles to customize the length. In yet another preferred embodiment, the hanging means 301 may comprise a hook. For example, the hook may be a heavy-duty metal hook capable of supporting the weight of the system and animal carcass. In some cases, the hook may include a swivel mechanism to allow the bag to rotate freely when suspended. In some preferred embodiments, the hanging means 301 may incorporate mechanisms to assist the user in hanging a heavy animal, such as a pulley operable by the user or a powered winch. For example, the hanging means 301 may include a block and tackle pulley system that allows the user to lift heavy carcasses with reduced effort. In another example, the hanging means 301 may incorporate an electric winch powered by a rechargeable battery pack, enabling automated lifting of large game animals. In other preferred embodiments, the hanging means 301 may feature a collapsible stand with an integrated pulley system, providing a portable solution for hanging carcasses in areas lacking suitable trees or structures.

The hanging means 301 is preferably capable of sustaining the weight of the system 100 for an extended period of time. The anchor point 302 may serve as a stable point to which the system can be affixed. In some implementations, the anchor point 302 may be one component of a larger anchor system 300. For example, the anchor point 302 may comprise a branch or limb of a tree, with the tree comprising the anchor system 300. Alternatively, the anchor point 302 may comprise a beam of an enclosing structure, such as a rafter of a garage or shed. This configuration may provide additional protection to the animal carcass from scavenging wildlife. In other preferred embodiments, the anchor point 302 may comprise a bar in a rack structure, which can be sturdy but easily relocated to facilitate hanging the system and enclosed animal carcass. It should be noted that this list of potential anchor points and anchor systems is not exhaustive; effectively any system or structure capable of bearing the weight of the system 100 and enclosed animal carcass may be contemplated and remain within the scope of this disclosure.

FIG. 7 illustrates a diagram 700 illustrating certain, preferred method steps by which a system 100 may be used to store, refrigerate, and transport animal carcasses. Step 705 indicates the beginning of the method. In branching step 710, the user determines whether or not they will hang the game animal for draining or storage. If hanging is not planned, the user proceeds to step 715. If hanging is planned, the user proceeds to step 730. In a preferred embodiment, the decision made at branching step 710 is informed by a variety of considerations, such as whether there is a safe inner cavity 109 to hang the carcass 200, the duration of time spent outdoors, the danger of attracting carnivorous wildlife, and the strength of the hanging means 301 and the anchor point 302 to which the system 100 would be attached.

In step 715, the system 100 is unzipped and opened such that the interior lining forms a single face directed upwards when laid upon the ground. In a preferred embodiment, the area is cleared of debris prior to opening the system 100 in this manner. In another preferred embodiment, the ground is flat, dry and lacking in angles that could risk the animal carcass rolling away. During step 720, the animal carcass 200 is placed on the system 100. In a preferred embodiment, the animal carcass 200 is placed on the interior lining of this insulated bag 101 such that the entirety of said carcass is on one half of the system 100, divided longitudinally. In another preferred embodiment, the animal carcass 200 has been subjected to field dressing. In yet another preferred embodiment, the animal carcass 200 has been subjected to field quartering. Generally, the animal carcass 200 should be prepared for transport prior to or during step 720. In step 725, the flat bag is folded over the animal carcass. In a preferred embodiment, the bag is folded such that the opening 105 of the bag is about the head and neck of the animal carcass.

In step 730, the animal carcass 200 is hung upon a gambrel 300 or other hanging means. In a preferred embodiment, this is accomplished by piercing the legs or other limbs with protruding spikes from the hanging gambrel. In another preferred embodiment, this is accomplished by wrapping one or more legs, other limbs, or main body with hanging straps. In yet another preferred embodiment, the piercing with a gambrel or wrapping with straps occurs on the ground, and the animal carcass 200 is then suspended via a mechanism like a pulley. In still another preferred embodiment, the animal carcass 200 is field dressed and suspended in a location where it is at reduced risk of exposure to carnivorous wildlife. In step 735, the bag is wrapped about the hanging animal carcass 200. In a preferred embodiment, the bag is wrapped starting from the back and moving to the stomach side. In another preferred embodiment, the bag is wrapped such that the head of the animal protrudes from the opening of the bag.

In step 740, the zipper 106 is aligned at the starting point and zipped closed to secure the bag about the animal carcass 200. In step 745, the opening 105 of the bag is cinched to secure about the head of the animal carcass 200 using the drawstring 105A. During step 750, the hanging straps 104 are wrapped about the legs of the animal carcass 200. In a preferred embodiment, the hanging straps 104 are furthermore wrapped about the body of the animal carcass 200 for additional stability. In another preferred embodiment, the hanging straps 104 are wrapped exclusively around the main body of the animal carcass 200. In still another preferred embodiment, the hanging straps 104 are wrapped around the gambrel or other hanging means to provide additional support to the animal carcass 200. In yet another preferred embodiment, the closable lining 111 is closed following this step.

During step 755, cold material is inserted into the ice channels 102. In a preferred embodiment, said cold material is inserted from the top of the ice channel 102. In another preferred embodiment, said cold material comprises ice in block, cubed, or crushed forms. In yet another preferred embodiment, said cold material comprises freezer packs. In still another preferred embodiment, said cold material comprises dry ice. In step 755, the tubular connector 107, including one or more recirculation hoses 107A/107B, is connected to the refrigeration unit 108. In step 760, the refrigeration unit 108 is turned on and cold air is directed into the inner cavity 109. Step 765 indicates the termination of the method.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

1. A system for preserving and transporting animal carcasses, comprising:
an insulated bag having multiple layers including an outer layer, a radiant heat-deflecting layer, an insulation layer, and an inner waterproof layer;
a refrigeration unit;
a tubular connector coupling the refrigeration unit to the insulated bag; and
at least one ice channel integrated within the insulated bag for holding cold material.

2. The system of claim 1, wherein the tubular connector comprises two hoses, a first hose for directing cold air into the insulated bag and a second hose for recirculating air back to the refrigeration unit.

3. The system of claim 1, further comprising hanging straps affixed to the insulated bag for securing an animal carcass within the bag.

4. The system of claim 3, wherein the hanging straps are adjustable in length and include quick-release mechanisms.

5. The system of claim 1, wherein the insulated bag includes a zipper running longitudinally from an opening of the bag to an opposite end, allowing the bag to fold open to form a flat configuration.

6. The system of claim 5, wherein the opening of the bag comprises a drawstring housing and a drawstring for adjusting the size of the opening.

7. The system of claim 6, further comprising a closable lining at the end opposite the opening, the closable lining configured to seal the bag when folded over itself.

8. A method of preserving an animal carcass, comprising:
placing an animal carcass in an insulated bag having multiple layers including an outer layer, a radiant heat-deflecting layer, an insulation layer, and an inner waterproof layer;
securing the animal carcass within the insulated bag;
inserting cold material into at least one ice channel integrated within the insulated bag; and
circulating cold air from a refrigeration unit into the insulated bag via a tubular connector.

9. The method of claim 8, further comprising hanging the insulated bag from an anchor point using a hanging loop attached to the insulated bag.

10. The method of claim 9, wherein securing the animal carcass within the insulated bag comprises wrapping hanging straps around portions of the animal carcass.

11. The method of claim 10, wherein the hanging straps are adjustable in length and include quick-release mechanisms.

12. The method of claim 8, wherein circulating cold air comprises directing cold air into the insulated bag through a first hose and recirculating air back to the refrigeration unit through a second hose.

13. The method of claim 8, further comprising cinching an opening of the insulated bag around a portion of the animal carcass using a drawstring.

14. The method of claim 13, further comprising sealing an end of the insulated bag opposite the opening using a closable lining.

15. An insulated bag for preserving animal carcasses, comprising:
a multi-layered structure including an outer layer, a radiant heat-deflecting layer, an insulation layer, and an inner waterproof layer;
at least one ice channel integrated within the multi-layered structure;
an access port configured to connect to a refrigeration unit; and
an adjustable opening with a drawstring for securing an animal carcass within the bag.

16. The insulated bag of claim 15, wherein the ice channels are positioned between the insulation layer and the inner waterproof layer.

17. The insulated bag of claim 16, wherein the ice channels comprise pockets with at least one open end for inserting and removing cold material.

18. The insulated bag of claim 17, wherein the at least one open end of the ice channels includes a sealable closure.

19. The insulated bag of claim 15, further comprising hanging straps affixed to the bag for securing an animal carcass within the bag.

20. The insulated bag of claim 19, wherein the hanging straps are adjustable in length and include quick-release mechanisms for easy attachment and detachment of the animal carcass.
